(19) United States
(12) Patent Application Publication
(10) Pub. No.: US 2007/0050121 A1
(43) Pub. Date: Mar. 1, 2007

(54) Method for determining a coefficient of friction

(76) Inventors: Dieter Ammon, Remseck (DE); Jorge Cases Andreu, Esslingen (DE); Gunther Mackle, Stuttgart (DE)

Correspondence Address: KLAUS J. BACH & ASSOCIATES, 4407 TWIN OAKS DRIVE, MURRYSVILLE, PA, 15668, US

(21) Appl. No.: 11/541,954

(22) Filed: Oct. 2, 2006

Related U.S. Application Data
(63) Continuation-in-part of application No. PCT/EP05/03145, filed on Mar. 24, 2005.

(30) Foreign Application Priority Data
Apr. 2, 2004 (DE) 10 2004 016 288.3

(51) Int. Cl. B60T 8/72

(52) U.S. Cl. 701/80; 701/73

(57) ABSTRACT

In a method for determining a coefficient of friction in which vibrations of a tire are measured and a frequency spectrum of the vibration of the tire is evaluated, the following steps are carried out: frequency signals are recorded in at least two frequency bands, amplitudes of the frequency signals are compared with empirical values which are dependent on the coefficient of friction and on a momentary force transmission state of the tire, a coefficient of friction is determined and a maximum available force which can be transmitted from the tire to the road surface is determined from the coefficient of friction.

This is a Continuation-In-Part Application of International PCT/EP2005/003145 filed Mar. 24, 2005 and claiming the priority of German application 10 2004 016 288.3 filed Apr. 2, 2001.

### BACKGROUND OF THE INVENTION

The invention relates to a method for determining a coefficient of friction wherein vibrations of a tire are detected and a frequency spectrum of the vibrations is evaluated.

The friction between a vehicle tire and the roads surface, which is necessary to transmit braking forces, acceleration forces and lateral guidance forces is dependent on the condition of the road surface, and when the road is wet it is dependent in particular on the film of water located on the road surface. Direct contact between the vehicle tire and the road surface is possible if the film of water can be expelled from a significant part of the flattened region of the vehicle tire.

Various methods are known with which the condition of the road surface is assessed. Furthermore, it is known for example from anti-lock brake systems (ABS) or traction control systems (ASR) that differences in wheel speeds between driven vehicle wheels and non-driven vehicle wheels are evaluated in order to detect a momentary coefficient of friction by reference to a wheel slip, and to intervene correspondingly in the driving operation.

DE 195 43 928 C2 discloses a method in which a risk of aquaplaning is detected early by sensing detuning of rotational intrinsic vibrations of tires and evaluating it. The detuning has a direct relationship with the size of the contact zone between the tire and road surface, which becomes constantly smaller on approaching the aquaplaning state.

It is the principal object of the present invention to provide a method for determining a coefficient of friction between a vehicle tire and the road surface such that the operational vehicle safety can further be increased.

### SUMMARY OF THE INVENTION

In a method for determining a coefficient of friction in which vibrations of a tire are measured and a frequency spectrum of the vibrations of the tire is evaluated, the following steps are carried out:
frequency signals are recorded in at least two frequency bands,
amplitudes of the frequency signals are compared with empirical values which are dependent on the coefficient of friction and on a momentary force transmission state of the tire,
a coefficient of friction is determined, and
a maximum available force which can be transmitted from the tire to the road surface is determined from the coefficient of friction.

In contrast to merely determining a momentary coefficient of friction, the method according to the invention permits an estimation of an available reserve of a force which can be transmitted between the tire and the road surface. Operating parameters of the vehicle such as the speed, torque, distance of a vehicle from a vehicle traveling in front and the like can be set correspondingly in order to keep the vehicle outside a critical driving state. This permits a particularly safe operating mode. A braking maneuver or avoiding maneuver can, for example, be preferably controlled as a function of the maximum available force which can be transmitted from the tire to the road surface.

It is particularly advantageous to make available the force reserve which is extracted from the method to, for example, an on-board vehicle movement dynamics control system or an assistance system in order thus to move the vehicle or issue a warning to the driver.

If a plausibility check is carried out between frequency signals of driven wheels and those of non-driven wheels it is possible to ensure that a malfunction is detected. As a rule, the tires of a vehicle are subject to the same peripheral conditions such as temperature, road conditions and the like. If the coefficients of friction for the tires of the driven wheels and those for the tires of the non-driven wheels do not correspond, this indicates a malfunction. A corresponding intervention in a vehicle control system is expediently not carried out in this case, however, a warning message may be issued, in particular if the coefficients of friction are included in the driving mode via a vehicle control system or assistance systems.

Preferably, frequency signals of the driven wheels and those of the non-driven wheels are used for compensating interference variables. This is advantageous since the tires are subject to essentially identical environmental conditions such as, for example, temperature, type of road surface and the like. The non-driven wheels are in the state of coasting in the driving mode so that differences in the behavior of the driven wheels compared to that of the non-driven wheels can be used to compensate for influences of the temperature or of the road surfaces. Further influencing variables can be taken into account by means of sensor data from on-board sensors and other information sources. States with specific minimum durations, whose length is dependent mainly on the resolution of the wheel speed sensors used, are expediently considered.

If the instant force transmission state is evaluated by reference to the driving states of rolling, accelerating/decelerating and/or cornering it is easily possible to determine a coefficient of friction which is adapted to a current driving state.

If the empirical values which are dependent on the coefficient of friction are used at least for the road surface states of dry, damp, wet, snow covering, ice covering, it is easily possible to determine a coefficient of friction which is adapted to a state of the road surface. To assess a current state of the road surface, it is possible to use information and sensor data which are available on board the vehicle in order to obtain plausible states. The search field can be restricted to appropriate states. By reference to the data it is possible to differentiate between winter and summer; for example, snow covering and ice covering can easily be disregarded in the summer, while in the winter these have to be taken into account under given weather conditions.

If a selection of relevant empirical values is made on the basis of sensor information, the time required for the calculation of the coefficient of friction and the estimation of the available force reserve can be minimized. A number of states which are to be considered is preferably restricted on the basis of the sensor information. Clearly inappropriate states do not need to be considered.

It is advantageous to calculate the maximum available force which can be transmitted from the tire to the road surface for each driven wheel. This increases the reliability of the determination of the coefficient of friction. If the determination of the coefficient of friction is used in a particularly advantageous way to operate the vehicle, by virtue of the fact that the maximum available force which can be transmitted from the tire to the road surface is conveyed to a driver assistance system of the vehicle, the operational reliability of vehicles which are equipped in such a way can be improved. In particular, a driving parameter can be set as a function of the maximum available force which can be transmitted from the tire to the road surface.

The invention will be explained below in more detail on the basis of an exemplary embodiment which is shown in the drawing. The drawing, the description and the claims contain numerous features in combination which can expediently also be considered individually and combined to form appropriate further combinations.

### BRIEF DESCRIPTION OF THE DRAWINGS

FIG. 1 shows a vehicle tire on a road surface, which is wet from rain,

FIGS. 2 a, b, c, d show a mechanical equivalent model of a vibration system comprising a road surface-contact area-tire belt rim with a torsion spring (a), a radial spring (b), with twisting of the wheel against its rim (c) and twisting of the tire belt in itself (d), and

FIGS. 3 a, b show frequency analysis data from a plurality of tires for a wet road surface (a) and dry road surface (a), and frequency analysis data for a tire on a wet road surface (b) and dry road surface (b).

### DESCRIPTION OF AN EXEMPLARY EMBODIMENT

The method described below is based on sensor information which is largely combined by means of specific model approaches from vehicle and tire physics in order to be able to make available coefficient of friction information with high resolution, quickly and at high quality. In this context, it is not only the momentary coefficient of friction between the tire and road surface that is determined but also a potential coefficient of friction is extracted which indicates how large a maximum force which can be transmitted between the tire and the road surface is, in particular how much room there is between the momentary state and the maximum transmissible force, i.e. what force reserve is still available. In addition, owing to the stored model concepts and the model adaptation which is thus necessary it is possible to acquire secondary information such as tire air pressure, height of tread or the presence of a risk of aquaplaning.

If a single tire is considered when traveling straight ahead at constant velocity v, virtually no information can be acquired about the potential coefficient of friction in the state of coasting. Even under the effect of drive forces in the sense of acceleration or of (moderate) braking the effective potential coefficient of friction is hardly visible in a steady-state fashion. It would be possible to carry out a (relatively precise) determination of the coefficient of friction only during a braking process which would trigger an anti-lock brake system (ABS), which is not practicable in the customary driving mode. However, if a frequency spectrum of tire vibrations is considered in the relatively high frequency range, information about the potential coefficient of friction becomes accessible which is based on the tire-road surface contact, on the vibration behavior and on the quasi-static deformations of the tire structure. Relatively high frequency is to be understood to be a frequency which is typically above 20 Hz.

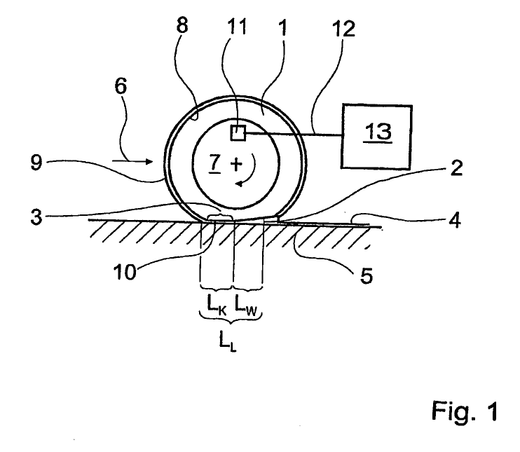

The tire is subjected to permanent vibration excitation owing to unevenness in the road surface and also due to a permanently present fluctuation in a drive torque or braking torque. The tire profile likewise contributes to these excitations. For example, FIG. 1 illustrates a tire 1 on a road surface 5 which is wet from rain. The tire 1 surrounds a rim 7 and moves in a direction 6 of travel. The tire 1 has on its circumference a tire belt 8 with an external tire profile 8. A wheel speed sensor 11 which is mounted on the rim 7 senses the rotational speed of said rim and passes on corresponding signals to an evaluation unit 13 via a signal path 12, which can also be wireless. A wedge 2 of water is formed under the tire 1 and in the direction of travel 6 in front of the tire 1 as a result of the flow equilibrium and force equilibrium, said wedge 2 of water greatly reducing a contact zone 3 between the tire 1 and the road surface 5 which is covered with a film 4 of water. The original contact zone 3 without a wedge 2 of water corresponds to the tire contact area L_{L}. Corresponding shortening of the force-transmitting contact zone 3 is associated with the formation of the wedge 2 of water between the tire 1 and road surface 5. In addition to modified engagement points of lateral forces of the tire and longitudinal forces of the tire there is thus an associated change in the longitudinal rigidity of the tire since the proportion of the area of a tread proportion 10 of the tire 1 which is in engagement with the road surface 5 and forms a frictional engagement is reduced in proportion to the length L_{W} of the wedge 2 of water. For example, a frequency spectrum is acquired from the data of the wheel speed sensor by means of a Fourier transformation.

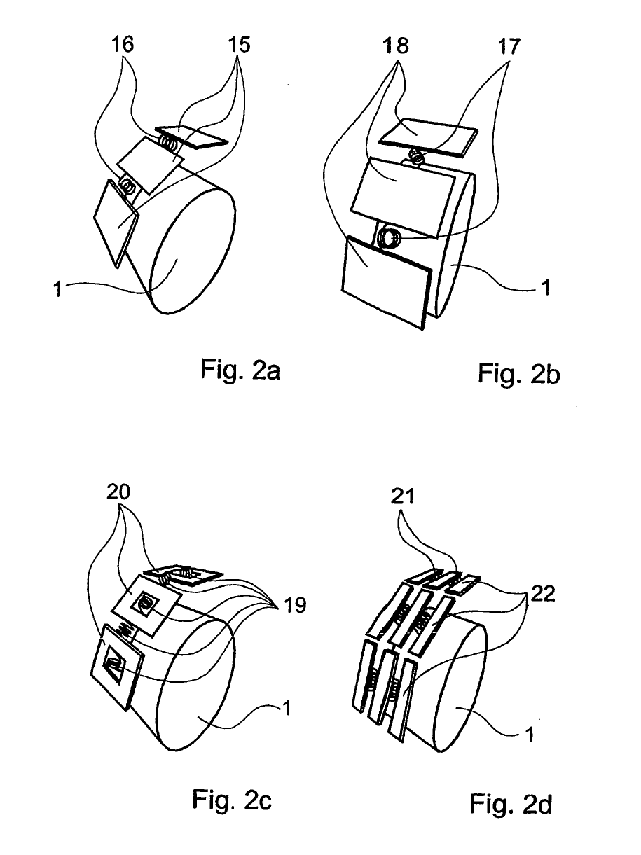

The vibration excitations of the tire belt 8 occur mainly in three degrees of freedom with rotation about a rotational axis of a wheel, translation in the longitudinal direction of the vehicle and translation in the vertical direction. These vibration excitations are generally weakly attenuated and are effectively coupled to one another by means of the tire-road surface contact zone, i.e. the tire contact area. FIGS. 2 a, b, c, d give an example of a modeling depth of a suitable model. Rigid body elements 15 are connected to a torsion spring 16 (FIG. 2a) and/or a radial spring 17 between individual rigid body elements 18 in which each rigid body element 18 is supported against the rim 7 (FIG. 2b) and/or the wheel 1 exhibits an inclination with springs 19 between and within rigid body elements 20 against its rim 7, and the springs 19 within and between the rigid body elements 20 can be different (FIG. 2c) and/or the tire belt 8 can be twisted in itself with springs 21 between rigid body elements 22 (FIG. 2d). In FIG. 2d, only a number of springs 21 and rigid body elements 22 are designated for the sake of clarity. According to requirements, a person skilled in the art will select a suitable modeling depth and a suitable model from appropriate models which are known per se.

The information on the resulting belt-contact area association can be extracted from targeted observation of, for example, the rotational oscillations of the rim, which can be sensed with the rotational speed sensor 11 (FIG. 1).

Most tread lugs in the tire-road surface contact zone 3 are normally adhering to the road surface 5, at low slip values and low skew values, by means of customary frictional adhesion contacts. Therefore, changes in the coefficient of friction cannot easily be detected by analyzing the tire characteristic curves in the driving mode, in particular this cannot be done if the coefficients of friction are high and the circumferential force vibrations are small. Although the ground pressure distributions disappear in principle at the edges of the contact area length, that is to say, assume values near zero, a number of lug areas are in a state of sliding or are near to their adhesion/sliding limits in all the operating states of the tire.

Even though this hardly influences the overall characteristics of the tire or the wear of the tire, the edge zone processes and the coasting sliding processes do influence the relatively high frequency tire vibrations above 20 Hz since, on the one hand, they influence the damping behavior per se an, on the other hand, depending on the change in the frictional adhesion conditions and sliding friction conditions, under certain circumstances they also generate additional so-called stick-slip excitations (stick-slip excitations are understood to be vibrations caused by stick-slip movements of the studs during tire deformation). When there are changes in circumferential forces and/or relatively large excitations of the road surface, these effects and the dynamic processes are used to make prognoses about a momentary tire-road surface potential coefficient of friction. Presented in simplified terms, when there is a high or good degree of friction between a tire and a road surface, almost all the locations virtually everywhere in the contact zone 3 adhere to the road surface 5. Consequently, the “genuine” sliding proportions and thus the effective damping of the tire belt vibrations are minimal. The sliding friction will primarily decrease on a damp or wet road surface 5, while the adhesion capability remains almost unchanged. Consequently, lug segments with limiting values will partially slide off, specifically sliding a greater distance the more “moisture lubrication” is present. The adhesion will also decrease on a wet road surface 5 or a road surface 5 which is flooded with water; as a consequence the damping increases further and stick-slip effects additionally occur. This model can also be referred to as a contact zone model. Depending on the height of the water, the tire 1 can also have a tendency to aquaplane, which can also be detected. Finally, entirely different adhesion/sliding conditions occur on ice and snow, and as a result different types of tire vibration conditions which can be more easily distinguished in comparison with normal operation also occur.

The method according to the invention for detecting a coefficient of friction can additionally include further parameters and influencing variables in order to supply results which are reliable in practice.

Thus, a driving state sensor system for contemporary ESP (Electronic Stability Program) systems for electronically stabilizing the driving behavior of the vehicle, such as for example a wheel speed sensor, steering angle sensor, rotational speed sensor and a lateral acceleration sensor, can advantageously be included in order to determine the current driving state of the vehicle. The ESP offers additional safety potential in critical situations and significantly reduces the risk of skidding when cornering. In the case of over-steering or under-steering of the vehicle, ESP intervenes, brakes a wheel selectively and brings the vehicle back onto its course. The inventive determination of the coefficient of friction between the tire 1 and road surface 5 enables such a system to react even earlier and provide an even better safety factor. On this basis it is possible to calculate specific operating conditions for each individual tire 1. The inventive determination of the coefficient of friction can be used for maintenance and/or for increasing the quantity of information as well as in other systems such as ABS (Anti-lock Brake System), ASR (traction control systems), automatic emergency braking systems, collision avoidance systems, etc.

The undisrupted tire reactions, from which the rotational oscillations of the wheel can be determined, can be calculated on the basis of a suitable model adaptation which is adapted to the vehicle. By comparison with the actually determined wheel speed data or rotational acceleration data for the wheel, which are preferably determined from a frequency analysis of a frequency spectrum of the wheel speeds, it is possible to separate the vibration behavior and the inherent dynamic behavior and find a suitable model adaptation by varying the friction parameters. This results in the suitable coefficients of friction from which the potential coefficient of friction which is being sought can be determined by means of the contact zone model.

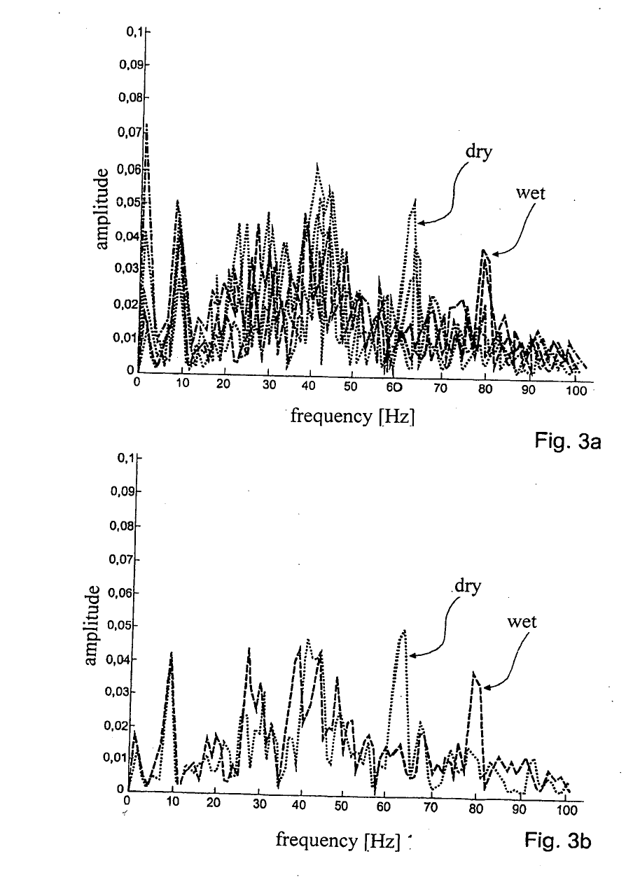

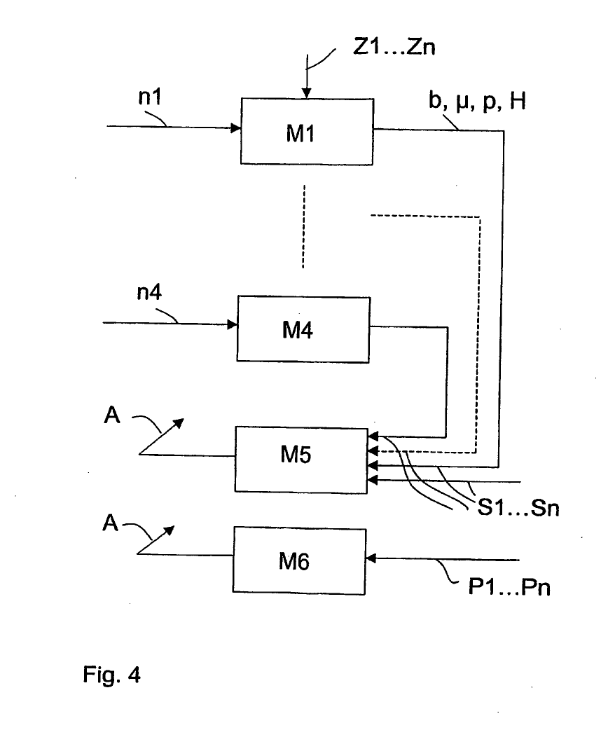

In this context, frequency signals of the frequency spectrum are first observed in at least two frequency bands. FIGS. 3 a, b show an example of measurements at a plurality of tires 1 or at one tire 1 at a constant velocity (70 km/h) on the same road surface 5 in a dry state and in a wet state. In a frequency band around 60 Hz, a maximum of an amplitude of a characteristic vibration occurs with a dry road surface (unbroken lines). The characteristic vibration can have a variation in the amplitude and also in the respective frequency of the maximum of the amplitude for each tire 1, but it is clearly apparent that the characteristic vibration on a wet road surface is shifted into a different frequency band by 80 Hz (dashed lines). In FIG. 3b, this shifting from one frequency band into the other is highlighted once more at the changeover from a dry road surface 5 to a wet road surface 5 for an individual tire 1. Therefore, if a signal is observed in the frequency band around 80 Hz, but no signal is observed in the frequency band around 60 Hz, this is characteristic of a vibration of the tire 1 on a wet road surface. If, conversely, vibration is observed in the frequency band around 60 Hz but none is observed in the frequency band around 80 Hz, this is characteristic of a vibration of the tire 1 on a dry road surface. In turn, a corresponding shift in the frequency of the characteristic vibration occurs on a snow-covered road surface or an ice-covered road surface.

As a result of the underlying model it is possible to calculate the frequency bands in which such a characteristic vibration occurs and in which states of the road surface, or it is possible to collect empirical values or acquire them from the model. The amplitude of the characteristic vibration is essentially proportional to the current coefficient of friction. From this it is possible to produce a relationship between the coefficient of friction and the amplitude. Furthermore, a corresponding relationship between the coefficient of friction and amplitude is obtained for each driving state, i.e. coasting, driving/braking, cornering. Therefore, if the driving state is known it is possible to derive, for example, a coefficient of friction around 60 Hz for the dry road surface 5 and around 80 Hz for the wet road surface 5 from the amplitude and the observation of the characteristic frequency bands. Furthermore, a maximum available force which can be transmitted from the tire 1 to the road surface 5 can be determined from the coefficient of friction value if the state of the road surface is known.

A force transmission state of the tire 1 which is characteristic of the state of the road surface can be determined for each state of the road surface, for example dry, wet, snow, ice etc. In order to recognize implausible measured values it is possible to carry out a plausibility check between frequency signals of driven wheels 1 and those of non-driven wheels 1 of the vehicle. For this reason, the method is suitable in particular for vehicles which have at least one non-driven axle.

In addition, frequency signals of the driven and of the non-driven wheels 1 can be used to compensate interference variables. Optionally, the maximum available force which can be transmitted from the tire to the road surface can be calculated for each driven wheel and passed on to a vehicle control system, a driver assistance system and the like in order to be able to operate the vehicle by utilizing the reserves and to avoid critical states. It is thus possible to set a driving parameter, for example a distance from a vehicle traveling in front, a velocity, an acceleration, a braking intervention, a gear speed and the like, as a function of the maximum available force which can be transmitted from the tire 1 to the road surface 5.

The evaluation can be simplified and speeded up if a selection of relevant parameters is made using sensor information and the number of states of the road surface to be considered is restricted, if appropriate, using the sensor information. In this context it is possible to combine sensor information in the sense of a sensor combination, with a plurality of sensor signals being logically combined to form one virtual sensor signal.

In this context it is possible to increase the signal quality by utilizing a redundancy between the individual sensor signals. In the optimum case, the positive properties are obtained for the signal of the sensor combination as a union set, and the negative properties of the sensors used as an intersection set. By comparing signals from different sensors it is also possible to detect systematic errors in the measuring systems. In addition, model-based estimation methods such as, for example, parameter estimation and/or Kalman filters are selected in order to suppress stochastic interference.

If different sensor information items are used it is possible, for example, to combine a temperature sensor with data from a weather station. For example, when there is a risk of frost an increased readiness to issue an alarm can be set at the vehicle. The data of the weather station can be transmitted to the vehicle via a digital traffic radio system. Furthermore, it may be significant to sense a temperature gradient. With a temperature dropping under already low temperature conditions, the risk of snow or frost increases.

In addition, both the air pressure and the air humidity can support a system for determining the coefficient of friction. Thus, an air pressure gradient may be a further means for detecting environmental conditions.

The position of the vehicle can be determined using GPS (Global Positioning System, a satellite-supported position-detecting system) data and conclusions can be drawn about the driver's surroundings by reference to maps. These conclusions include, for example, the current altitude of the vehicle and thus an associated snowfall limit, conclusions about bridges, forest areas, areas with relatively high humidity such as, for example, river valleys which entail a relatively high risk of moisture or frost on the road surface. It is thus possible also to detect by means of GPS whether the vehicle is moving on a main road or a secondary road which is less well constructed and maintained. Thus, on relatively small roads in the vicinity of fields there is more likely to be dirt on the road surface 5 than on a freeway, which dirt can significantly reduce the coefficient of friction between wheels 1 and road surface 5 in the event of rain.

A rain sensor can, on the one hand, be used to detect whether there is precipitation at all, but it can also be used to determine the quantity of precipitation, for example in combination with a velocity sensor and/or a current windshield wiper setting which is faster in heavy rain and slower in the case of slight precipitation.

Weather detection can be further improved by registering the date and time by means of a calendar. Thus, snow is less probable in a summer month than in a winter month. In addition, the risk of frost is dependent on the time of day, with the risk of ice on the road surface 5 increasing in the early hours of the morning and in the evening. There is likely to be foliage on the road in the autumn months, while in the summer the environmental conditions are usually better than at other times of the year.

In order to detect the state of the road surface it is possible use optical sensors which, for example, detect reflective surfaces such as a wet road surface or ice, or utilize light absorption properties of ice, snow or foliage.

It is likewise possible for an RDS/TCM traffic radio system (Radio Data Service/Traffic Message Channel) to transmit information about the weather, conditions of the road surface, local frost regions. In combination with a connected GPS system it is possible to perform further verification of the current position of the vehicle. An alarm state can be triggered if the road surface is in a poor condition or there is bad weather.

A logic system can use data from a light sensor from individual vehicle models or information about the state of headlights to evaluate whether it is light or dark. In the dark, the risk of ground frost is greater than in daylight. Combining the light sensor with a time signal appropriately allows influences of road lighting at night or dark rain clouds during the day to be excluded.

Furthermore, a wind detection means, for example by using the ESP sensor system in a preferred combination with GPS data and a means for detecting the date, permits early detection of foliage on the road or a road surface which is freezing over.

In addition, data can be exchanged between vehicles by means of modern assistance systems, this being in particular data relating to the coefficient of friction so that vehicles traveling behind can adjust themselves to approaching road surface conditions.

Tire pressure sensors can check the tire pressure at any time and take into account a drop in the coefficient of friction when the tire pressure is low; a warning message can also be issued.

The vehicle can monitor the soiling of headlights, in particular xenon headlights, by means of a dirt sensor which operates according to a principle which is comparable with the rain sensor. When the road surface is wet, dirt and/or water is possibly thrown up to the level of the headlights, but not as far as the windshield. A wet or soiled road surface can thus be detected more easily even if it is not raining at the time. A person skilled in the art will also use further appropriate sensor information and make reasonable combinations.

When gravel roads and other uneven road surfaces, for example cobblestone surfaces, are traveled, the evaluation of the wheel speeds does not supply a satisfactory result. Information from a spring travel sensor of an ABC (Active Body Control) chassis system or from an air spring system can initiate the issuing of a corresponding warning that a reduction in the coefficient of friction is to be expected.

What is claimed is:

1. A method for determining a coefficient of friction of a vehicle tire (1) on a road surface (5) wherein vibrations of the tire (1) are measured and a frequency spectrum of the vibration of the tire (1) is evaluated, said method comprising the following steps:
recording tire vibration frequency signals in at least two frequency bands,
comparing amplitudes of the frequency signals with empirical values which are dependent on the coefficient of friction and on a momentary force transmission state of the tire (1),
determining a coefficient of friction and
determining from the coefficient of friction a maximum force which can be transmitted from the tire (1) to the road surface (5).

2. The method as claimed in claim 1, wherein a plausibility check is carried out comparing frequency signals of the tires (1) of driven wheels with those of non-driven wheels.

3. The method as claimed in claim 2, wherein frequency signals of the tires (1) of the driven wheels and those of the non-driven wheels are used for compensating for disturbance interference variables.

4. The method as claimed in claim 1, wherein a momentary force transmission state is evaluated based on the driving states of rolling, accelerating/decelerating and/or cornering.

5. The method as claimed in claim 1, wherein the empirical values which are dependent on the coefficient of friction are used at least for the road surface conditions of dry, damp, wet, snow covering, ice.

6. The method as claimed in claim 1, wherein a selection of relevant empirical values is made on the basis of sensor information.

7. The method as claimed in claim 1, wherein the number of conditions to be considered is restricted on the basis of the sensor information.

8. The method as claimed in claim 1, wherein the maximum available force which can be transmitted from the tire (1) to the road surface (5) is calculated for each driven wheel.
